(19) United States
(12) Patent Application Publication
(10) Pub. No.: US 2009/0244774 A1
(43) Pub. Date: Oct. 1, 2009

(54) MAGNETIC RECORDING MEDIUM AND PROCESS OF PRODUCING THE SAME

(75) Inventors: Kyouhisa UCHIUMI, Odawara-shi (JP); Michinobu FUJISAWA, Odawara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/407,022

(22) Filed: Mar. 19, 2009

(30) Foreign Application Priority Data
Mar. 27, 2008 (JP) 2008-084796

(51) Int. Cl. G11B 5/78; B05D 5/12

(52) U.S. Cl. 360/134; 427/132; G9B/5.291

(57) ABSTRACT

A magnetic recording medium includes a support and a magnetic layer containing a ferromagnetic powder and a binder, and has a cut surface along an edge of the magnetic recording medium, wherein the cut surface of the magnetic recording medium has a shear region whose length in a thickness direction of the magnetic recording medium is at least 50% of the thickness of the magnetic recording medium.

### CROSS-REFERENCE TO RELATED APPLICATIONS

This application claims the benefit of Japanese Patent Application JP 2008-084796, filed Mar. 27, 2008, the entire content of which is hereby incorporated by reference, the same as if set forth at length.

### FIELD OF THE INVENTION

This invention relates to a magnetic recording medium and a process of producing the same. More particularly, it relates to a magnetic recording medium having a low dropout level, excellent servo performance, and high running durability and a process for producing the same.

### BACKGROUND OF THE INVENTION

A magnetic recording tape has its linear recording density markedly increased year by year with the increase of recording density. Consequently, adhesion of submicron dust and debris to a servo writer or a drive head causes a servo or write signal dropout, resulting in a failure to write a signal and leading to a quality error. Dust and debris deposited on the controller of a servo writer accelerates servo writing position error or edge deformation, resulting in a quality error.

In order to ensure the performance requirements of a magnetic recording tape, it is important to produce it without involving dust and debris generation. The problem confronting us is that the projections along a tape edge formed as a result of slitting operation generate a large amount of dust and debris that can adhere to a tape guide, a servo writer controller, and a drive head to cause errors. With the recent tendency to reduce the tape thickness, the area of the tape edge contact surface decreases, and the planar pressure to the tape edge contact surface increases accordingly. As a result, the tape edge is scraped off to produce an increased amount of debris. In this regard, improvements have been desired.

Known magnetic recording tapes contemplated to control debris generation from tape edges include a magnetic tape whose slit surface on each of the non-restrained side and the restrained side has such a surface profile with the apex of the highest protrusion of the support not protruding beyond a line connecting the apex of the highest protrusion of the coating layer and the apex of the highest protrusion of the backcoat layer (see, e.g., JP-A-2005-251331 (corresponding to US2005/0196648A1)). A magnetic tape whose slit surface on the reference edge side has such a surface profile with the edge of the support protruding in the tape width direction beyond the edge of the magnetic layer (see, e.g., JP-A-2005-317068) and a magnetic tape whose slit surface on the non-restrained side has such a surface profile that the height of the highest protrusion of the magnetic layer is 1 μm or less (see, e.g., JP-A-2005-339593 (corresponding to US2005/0260457A1)) are also known.

### SUMMARY OF THE INVENTION

The magnetic tape according to JP-A-2005-251331 (corresponding to US2005/0196648A1) is liable to the objection that, because the coating layer and the backcoat layer are thinner than the support, the support is allowed to protrude and be scraped by a tape guiding system to generate debris. According to JP-A-2005-317068 in which the protrusion of the coating layer is smaller in height than the protrusion of the support, if the difference in height between the protrusions is large, the protrusion of the support is so sharp with a small contact area with a tape guide that it is scraped off by the guide to generate debris. Similarly, the magnetic tape of JP-A-2005-339593 (corresponding to US2005/0260457A1) is highly likely to produce debris as a result of scraping the protruding magnetic layer on the slit surface by the guiding system, leaving room for improvement.

Accordingly, an object of the present invention is to provide a magnetic recording medium which is less likely to produce dust and debris during running due to scraping its edges by a tape guide, the position controller of a servo writer, a drive head, and the like and therefore exhibits decreased dropout levels, excellent servo tracking performance, and high running durability. Another object of the invention is to provide a process of producing the magnetic recording medium.

The above object of the invention is accomplished by the provision of a cut-to-size magnetic recording medium which includes a support and a magnetic layer containing at least a ferromagnetic powder and a binder on the support. The cut surface of the magnetic recording medium has a shear region in a ratio of at least 50% to the thickness of the magnetic recording medium (the cut surface of the magnetic recording medium has a shear region whose length in a thickness direction of the magnetic recording medium is at least 50% of the thickness of the magnetic recording medium).

The shear region, which is relatively smooth, of the slit surface occupies 50% or more of the thickness of the magnetic recording medium. This means that the slit surface has a large contact area with a so reduced planar pressure between the shear region and a guide, the position controller of a servo writer, a drive head, and so on. As a result, production of debris from the magnetic recording medium edge during running is prevented.

As the shear region increases, protrusion of the magnetic or nonmagnetic layer on the edge surface as a result of fracture reduces relatively. This also minimizes debris generation due to the contact with a guide or a drive head. As a result, there is obtained a magnetic recording medium having a low dropout level, excellent servo performance, and high running durability.

To accomplish the above object, the invention provides a preferred embodiment (1), in which the magnetic recording medium is a magnetic recording tape.

The preferred embodiment (1) provides a magnetic recording tape that involves minimal debris generation while running in contact with a guide, the position controller of a servo writer, a drive head, etc. and therefore exhibits a low dropout level, superior servo performance, and high running durability.

The invention also provides a preferred embodiment (2), in which the magnetic recording medium is a magnetic recording tape of linear recording system.

The preferred embodiment (2) provides a linear recording tape in which a servo track is provided in the tape longitudinal direction at a predetermined distance from one edge of the tape. The linear recording tape exhibits improved servo tracking performance because the distance of the servo track from the smooth edge shear region is less likely to vary.

The invention also provides a preferred embodiment (3), in which the support has a Young's modulus of 8 GPa or more in its width direction.

According to the embodiment (3), the high stiffness of the support permits the support to have a reduced thickness while securing strength necessary as a magnetic recording medium, thereby to provide an increased memory capacity.

The invention also provides a preferred embodiment (4), in which the magnetic recording medium is obtained by slitting a magnetic recording web into tapes with a width of 12.7 mm or less. The magnetic recording web includes a support having a thickness of 7 μm or less and at least two thin layers coating the support and has a total thickness of 9 μm or less.

The magnetic recording tape according to the embodiment (4) is prevented from generating dust and debris from its edges when scraped with a guide, the position controller of a servo writer, a drive head, and the like while running and therefore exhibits excellent servo performance and reduced dropouts.

The invention also provides a preferred embodiment (5), in which the magnetic recording medium is obtained by introducing a magnetic recording web between a rotating lower blade and a rotating upper blade mating with the lower blade at a depth of engagement of 0.05 to 0.2 mm to cut the web to size.

According to the embodiment (5), the resulting cut-to-size magnetic recording medium has a cut surface with a shear region in a ratio of at least 50% to the thickness of the magnetic recording medium. As a result, debris generation from the cut surface due to the contact with a guide or a drive head is minimized, and the magnetic recording medium has reduced dropouts, excellent servo performance, and high running durability.

The invention also provides a preferred embodiment (6) in which the magnetic recording medium is obtained by introducing a magnetic recording web between a rotating lower blade and a rotating upper blade mating with the lower blade at a depth of engagement of 0.2 to 0.5 mm at a speed of 100 to 200 m/min to cut the web to size.

According to the embodiment (6), the resulting cut-to-size magnetic recording medium has a cut surface with a shear region in a ratio of at least 50% to the thickness of the magnetic recording medium. As a result, debris generation from the cut surface due to the contact with a guide or a drive head is minimized, and the magnetic recording medium has a low dropout level, excellent servo performance, and high running durability.

The object of the invention is also accomplished by the provision of a first process of producing a cut-to-size magnetic recording medium that includes a support and a magnetic layer containing at least a ferromagnetic powder and a binder on the support. The process includes the step of introducing a magnetic recording web between a rotating lower blade and a rotating upper blade mating with the lower blade at a depth of engagement of 0.05 to 0.2 mm to cut the web to size.

According to the first process of the present invention, there is obtained a magnetic recording medium the cut surface of which has a shear region in a ratio of at least 50% to the thickness of the magnetic recording medium. The resulting cut-to-size magnetic recording medium produces a minimized amount of debris from its cut surface due to the contact with a guide or a drive head and therefore exhibits a low dropout level, excellent servo performance, and high running durability.

The object of the invention is also accomplished by the provision of a second process of producing a cut-to-size magnetic recording medium that includes a support and a magnetic layer containing at least a ferromagnetic powder and a binder on the support. The process includes the step of introducing a magnetic recording web between a rotating lower blade and a rotating upper blade mating with the lower blade at a depth of engagement of 0.2 to 0.5 mm at a speed of 100 to 200 m/min to cut the web to size.

According to the second process of the present invention, there is obtained a magnetic recording medium the cut surface of which has a shear region in a ratio of at least 50% to the thickness of the magnetic recording medium. The resulting magnetic recording medium generates a minimized amount of debris from its cut surface due to the contact with a guide or a drive head and therefore exhibits a low dropout level, excellent servo performance, and high running durability.

The present invention provides a magnetic recording medium that is prevented from generating dust and debris from scraping its edge with a guide, the position controller of a servo writer, a drive head, and so forth during running and thereby has a low dropout level, excellent servo performance, and high running durability. The invention also provides a process of producing the magnetic recording medium.

### BRIEF DESCRIPTION OF THE DRAWINGS

FIG. 1 is a perspective of an essential part of a slitter with which to obtain a magnetic recording medium of the invention.

FIG. 2 is a fragmental, longitudinal cross-section of an essential part of the slitter.

FIG. 3 is a side view of the slitter.

FIG. 4 shows enlarged cut surface profiles of magnetic recording tapes.

FIG. 5 is an enlarged side view of a magnetic recording web being slit into tapes.

FIG. 6A, FIG. 6B, FIG. 6C, and FIG. 6D are schematic diagrams showing the progress of shear cut of a magnetic recording web.

### DETAILED DESCRIPTION OF THE INVENTION

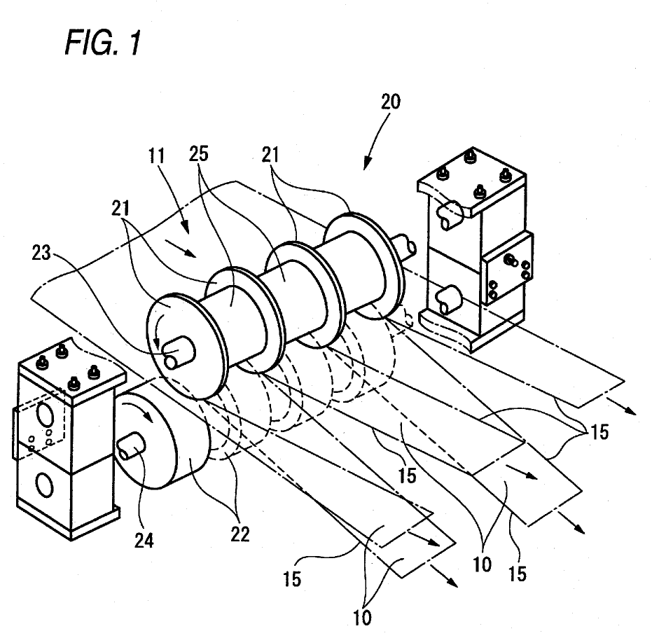

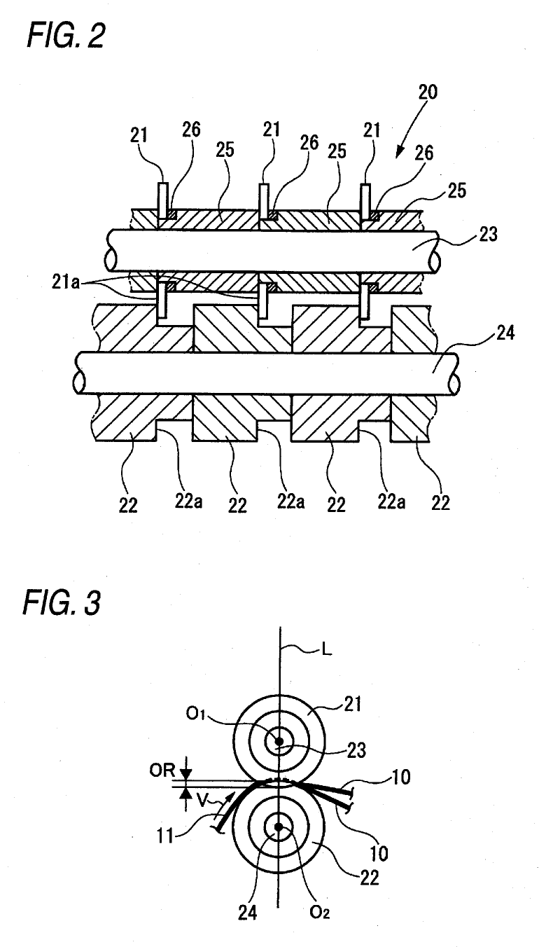

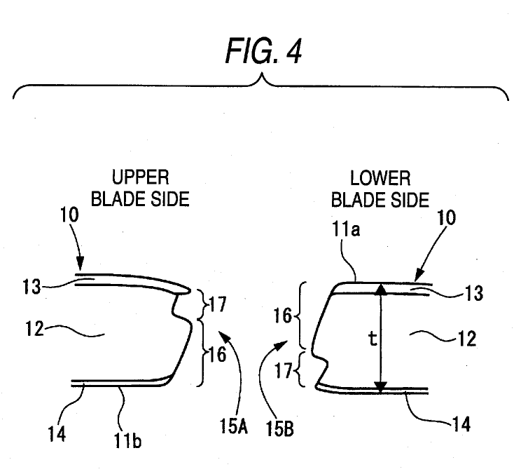

The present invention will be described in detail based on its preferred embodiments with reference to accompanying drawings. FIG. 1 is a perspective of an essential part of a slitter used to slit a magnetic recording web to make a magnetic recording medium of the invention. FIG. 2 is a fragmental cross-section of the slitter. FIG. 3 is a side view of the slitter. FIG. 4 represents an enlarged view of slit surfaces of a magnetic recording web facing to each other.

As illustrated in FIG. 1, a magnetic recording medium (magnetic recording tape) 10 according to the invention is obtained by slitting a magnetic recording web 11 into strips (tapes) by means of a slitter 20 in a manner such that each of the opposite edges of every strip may have a slit surface 15 having a shear region extending over at least 50% of the thickness of the magnetic recording medium 10.

As illustrated in FIG. 4, the web 11 or the magnetic recording medium 10 includes a support 12, a magnetic layer 13 containing a ferromagnetic powder and a binder on one side of the support 12, and a backcoat layer on the other side of the support 12. The web 11 or the magnetic recording medium 10 may optionally include a nonmagnetic layer containing a nonmagnetic powder and a binder between the support 12 and the magnetic layer 13.

The support 12 that can be used in the invention can be of polyethylene naphthalate (PEN), polyethylene terephthalate (PET), polyamide, polyimide, aromatic polyamide, polybenzoxazole, etc. A metal oxide film of, for example, AlOx, SiOx may be provided on at least one side of the support.

The magnetic layer 13 is basically made of a ferromagnetic powder and a binder. The magnetic layer usually contains a lubricant, an electroconductive powder (e.g., carbon black), and an abrasive. Examples of the ferromagnetic powder include ferromagnetic metal powders and tabular hexagonal ferrite powders. Examples of the binder include thermoplastic resins, thermosetting resins, reactive resins, and mixtures thereof.

The backcoat layer 14 is preferably made of carbon black and inorganic powder having a Mohs hardness of 5 to 9 dispersed in a binder. Examples of the inorganic powder include α-iron oxide, α-alumina, and chromium oxide (Cr₂O₃). Examples of the binder include a nitrocellulose resin, a polyurethane resin, a polyester resin, a polyisocyanate, and combinations thereof.

The nonmagnetic layer may be made of, for example, a nonmagnetic inorganic powder, carbon black, a lubricant, and a binder. Examples of the nonmagnetic powder include titanium oxide, α-alumina, α-iron oxide, and chromium oxide. Examples of the binder are the same as recited with respect to the magnetic layer.

The magnetic recording medium 10 is obtained by, for example, slitting a magnetic recording web 11 including a support having a thickness of 7 μm or less and at least two coating layers on the support 12 and having a total thickness of 9 μm or less into tapes with a width of 12.7 mm or less by means of the slitter 20.

As shown in FIGS. 1 and 2, the slitter 20 is mainly composed of vertical sets of a rotating upper blade 21 and a rotating lower blade 22. The web 11 is fed into between the upper blade 21 and the lower blade 22 to be slit in its longitudinal direction to obtain strips (magnetic recording tapes 10).

The lower blades 22 are each a hollow circular cylinder made of a metallic material, such as tungsten carbide, SKH, or a cermet, and are fitted over a rotating shaft 24 at a given interval. The rotating shaft 24 is driven by a motor (not shown). One side (the right hand side in FIG. 2) of each lower blade 22 provides a generally circular cutting surface 22a. The cutting surfaces 22a of the lower blades 22 are arranged in the axial direction of the rotating shaft 24 at the same interval as the width of the magnetic tape 10.

The upper blades are each a thin disk made of an ultra hard material, such as tungsten carbide, and are secured around a rotating shaft 23 at a given interval. The rotating shaft 23 is placed parallel to the rotating shaft 24 having the lower blades 22 fitted thereon and driven by a motor. A spacer 25 is fitted in between adjacent upper blades 21 so that the upper blades 21 may be regularly spaced along the axial direction of the rotating shaft 23.

The upper blade 21 is positioned such that its cutting edge may enter the gap formed between adjacent lower blades 22, that is, the lower cutting edge of the upper blade 21 and the upper cutting edge of the lower blade 22 may overlap each other in their radial directions when viewed from a side. One side (the left hand side of FIG. 2) of the upper blade 21 provides a cutting surface 21a that effects a shear cut in sliding contact with the cutting surface 22a of the lower blade 22.

The upper blade 21 is urged in the thrust direction (to the left in FIG. 2) by an elastic member 26, such as a spring or rubber, and thus prevented from being separated away from the lower blade 22 by the resistance of the web 11 being cut. As a result, the cutting surface 22a of the lower blade 22 and the cutting surface 21a of the upper blade 21 are constantly in contact with each other to maintain satisfactory engagement.

Thus, the cutting surface 21a of the upper blade 21 is in sliding contact with the cutting surface 22a of the lower blade 22a to produce a shear cutting action, whereby the magnetic recording web 11 is slit into a plurality of magnetic recording tapes with a width of 12.7 mm or less.

As illustrated in FIG. 3, the overlap between the upper blade 21 and the lower blade 22 on segment L connecting the center O1 of the upper blade 21 and the center O2 of the lower blade 22 is defined to be the depth OR of engagement (hereinafter “engagement depth OR”). The engagement depth OR is set at, for example, 0.05 mm to 0.2 mm. With OR being set at less than 0.05 mm, the OR can become less than 0 during cutting operation by the influence of radial runout only to provide a low quality cut, resulting in a failure to separate adjacent magnetic recording tapes 10. With the OR exceeding 0.2 mm, the shear region of the cut surface tends to be less than 50% of the thickness of the magnetic tape 10.

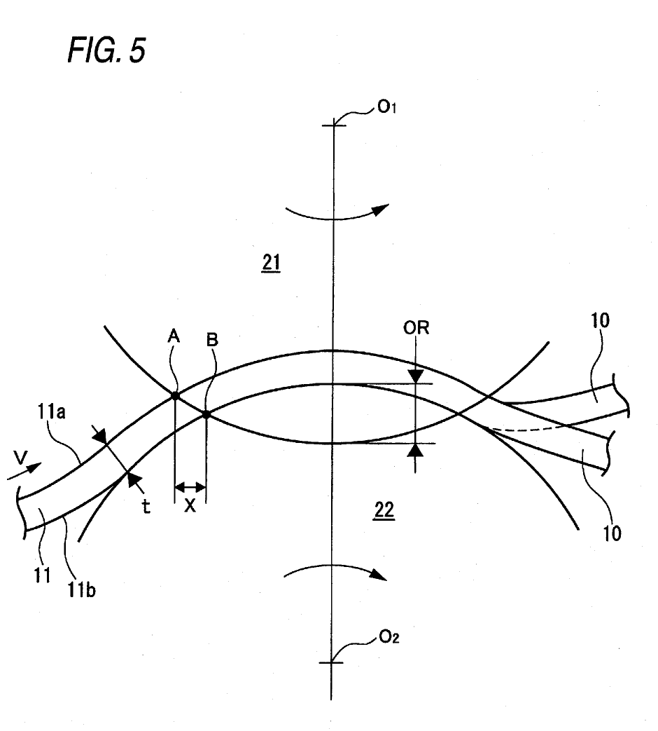

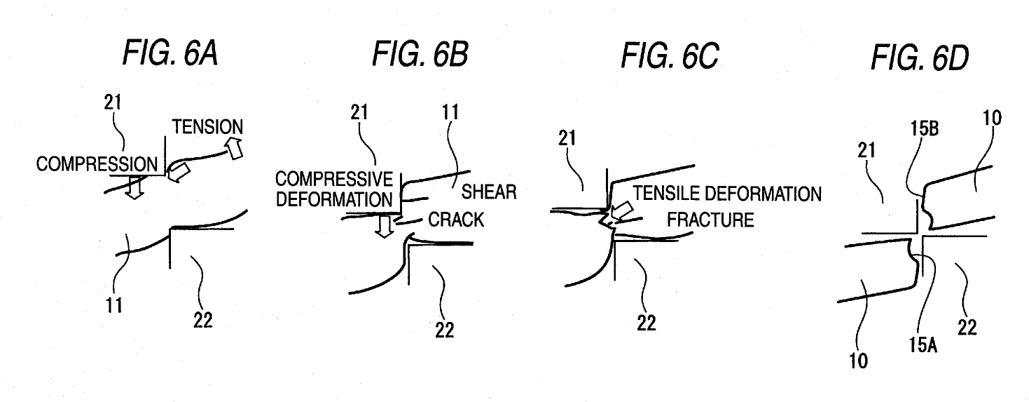

Cutting of the magnetic recording web will then be described in detail by way of FIGS. 4 through 6. FIG. 5 presents a side view of a magnetic recording web being slit into tapes with rotating blades. FIGS. 6A to 6C are schematic diagrams showing the progress of shear cut of a magnetic recording web.

For the sake of convenience of description, it is to be understood that a magnetic recording web 11 is fed with its lower side 11b in contact with the rotating lower blade 22 as illustrated in FIG. 5. Cutting of the web 11 starts from point A where the upper side 11a of the web 11 comes into contact with the rotating upper blade 21 and completes at point B where the outer periphery of the upper blade 21 and that of the lower blade 22 intersect with each other. In more detail, upon contact between the upper side 11a of the web 11 and the upper blade 21, the web 11 is clamped between the upper blade 21 and the lower blade 22, and a compressive stress is exerted to the upper blade side of the web 11 while a tensile stress is applied to the lower blade side of the web 11 as illustrated in FIG. 6A. At this point, the web 11 tilts due to rotational moment.

As the web 11 proceeds between the upper blade 21 and the lower blade 22, the distance between the upper and the lower blades 21 and 22 decreases as illustrated in FIG. 6B, whereupon the stress applied to the web 11 increases gradually to increase compressive deformation. As a result, a shear crack occurs in the web 11, and the shear proceeds gradually. As the distance between the blades 21 and 22 further decreases as illustrated in FIG. 6C, the compressive deformation proceeds further. When the tensile stress eventually reaches the fracture stress of the web 11, a fracture occurs, and the web is cut into a plurality of magnetic recording tapes 10 as illustrated in FIG. 6D.

As a result of the cutting by the shear action followed by the fracture action as described above, there are produced two facing cut surfaces 15A and 15B having different profiles as illustrated in FIG. 4. The cut surface 15A is of the magnetic recording tape 10 that has been in contact with the upper blade 21 (hereinafter referred to as “the upper blade side cut surface”), while the cut surface 15B is of the magnetic recording tape 10 that has been in contact with the lower blade 22 (hereinafter referred to as “the lower blade side cut surface”). The upper blade side cut surface 15A has a shear region 16 and a fracture region 17 in the order from the lower side 11b. The lower blade side cut surface 15B has a shear region 16 and a fracture region 17 in the order from the upper side 11a.

The sizes of the shear regions 16 and the fracture regions 17 of the cut surfaces 15A and 15B depend on the cutting conditions including the engagement depth OR between the upper and the lower blades 21 and 22 and the web cutting speed V. In general, slower cutting results in a larger proportion of the shear region 16. This is believed to be because, when cutting is completed in a short time, the web material hardens on account of cutting speed dependency of viscoelasticity so that a fracture initiates in an early stage of cutting.

The shear region 16 generally has a relatively smooth surface, whereas the fracture region 17 generally has a rough surface. Since it is desirable for the magnetic recording tape 10 to generate no dust and debris during running, it is preferred that the shear region 16 be large.

As understood from FIG. 5, according as the engagement depth OR between the upper and lower blades 21 and 22 decreases, the distance X between points A and B increases (i.e., the cutting time increases) so that the proportion of the shear region 16 increases. Accordingly, the engagement depth OR is desirably as small as possible within a range enabling cutting the web 11. For the same reason, the web cutting speed V is desirably as low as possible.

As stated, it is desirable that the ratio of the shear region 16 to the thickness t of the magnetic tape 10 be high to minimize dust and debris generation. In order to find the cutting conditions that achieve the ratio of the shear region 16 of 50% or more, the inventors performed a test of cutting a magnetic recording web 11 prepared by coating a 7 μm thick support 12 with a thin layer to give a total thickness of 9 μm or less. The cutting was carried out using a 140 mm diameter upper blade 21 and a 130 mm diameter lower blade 22 (both blades having a tip angle of about 90°) while varying the engagement depth OR between the blades 21 and 22 and the cutting speed V (i.e., the velocity of the web 11). The results obtained are shown in Table 1 below.

TABLE 1

| | OR (mm) | | | | | | | | |
|---|---|---|---|---|---|---|---|---|---|
| | 0.5 | 0.5 | 0.5 | 0.2 | 0.2 | 0.2 | 0.05 | 0.05 | 0.05 |
| V | 400 | 200 | 100 | 400 | 200 | 100 | 400 | 200 | 100 |
| (m/min) | | | | | | | | | |
| Shear | 42/ | 51/ | 65/ | 55/ | 62/ | 78/ | 64/ | 77/ | 84/ |
| Region | 38 | 53 | 63 | 58 | 66 | 81 | 62 | 80 | 86 |
| Ratio* | | | | | | | | | |
| (%) | | | | | | | | | |

Note:
*upper blade side cur surface/lower blade side cut surface

As shown in Table 1, the ratio of the shear region 16 to the thickness t of the magnetic tape 10 increases with decreases in OR and V. It is understood from the results that a cut surface whose shear region 16 occupies at least 50% of the thickness t of the magnetic tape 10 is obtained by setting the cutting speed V to 200 m/min or less with the engagement depth OR of 0.5 mm or by setting the engagement depth OR to 0.2 mm or less, preferably 0.05 mm, with the cutting speed V of 400 m/min.

In short, the cutting conditions that achieve the ratio of the shear region 16 of 50% or more to the thickness t of the magnetic recording tape 10 are (1) that the engagement depth OR between the upper and lower blades 21 and 22 is 0.05 to 0.2 mm or (2) that the engagement depth OR is 0.2 to 0.5 mm with the cutting speed V being 100 to 200 m/min.

The above described embodiments provide a magnetic recording medium 10 and a process of producing the medium 10. The magnetic recording medium 10 is prevented from generating dust and debris from its cut edges while running in contact with a guide, the position controller of a servo writer, a drive head, and the like and therefore exhibits a low dropout level, superior servo performance, and high running durability.

### EXAMPLES

The present invention will now be illustrated in greater detail with reference to Examples and Comparative Examples.

### Examples 1 to 3 and Comparative Examples 1 to 3

A magnetic recording web was prepared as follows. All the parts are by mass.

### (1) Preparation of Magnetic Coating Composition

A hundred parts of acicular ferromagnetic alloy powder (Hc: 175 kA/m (2200 Oe); BET specific surface area: 70 m²/g; particle size (length): 45 nm; aspect ratio: 4; σs: 125 A·m²/kg (125 emu/g)) was pulverized in an open kneader for 10 minutes. Ten parts (on a solid basis) of an SO₃Na-containing polyurethane solution (solid content: 30%; SO₃Na content: 70 μeq/g; weight average molecular weight: 80,000) and then 30 parts of cyclohexanone were added to the powder, followed by kneading for 60 minutes. To the mixture were further added 2 parts of an α-Al₂O₃ abrasive (particle size: 0.3 μm), 2 parts of carbon black (particle size: 40 μm), and 200 parts of a 1/1 mixed solvent of methyl ethyl ketone (MEK) and toluene, followed by dispersing in a sand mill for 120 minutes. Two parts of butyl stearate, 1 part of stearic acid, and 50 parts of MEK were added thereto, and the mixture was stirred for 20 minutes and filtered through a filter having an average pore size of 1 μm to prepare a magnetic coating composition.

### (2) Preparation of Nonmagnetic Coating Composition

A hundred parts of α-Fe₂O₃ (average particle size: 0.15 μm; BET specific surface area: 52 m²/g; surface treatment layer: Al₂O₃, SiO₂; pH: 6.5-8.0) was pulverized in an open kneader for 10 minutes, and 15 parts (on a solid basis) of an SO₃Na-containing polyurethane solution (solid content: 30%; SO₃Na content: 70 μeq/g; weight average molecular weight: 80,000) and then 30 parts of cyclohexanone were added thereto, followed by kneading for 60 minutes. Two hundred parts of a 6/4 mixed solvent of MEK and cyclohexanone was added, followed by dispersing in a sand mill for 120 minutes. Two parts of butyl stearate, 1 part of stearic acid, and 50 parts of MEK were added thereto, and the mixture was stirred for 20 minutes and filtered through a filter having an average pore size of 1 μm to prepare a nonmagnetic coating composition.

### (3) Preparation of Backcoating Composition

### Mixture A:

| | |
|---|---|
| Carbon black A (particle size: 40 nm) | 100 parts |
| Nitrocellulose RS1/2 | 50 parts |
| Polyurethane resin (Tg: 50° C.) | 40 parts |
| Dispersant system | |
| Copper oleate | 5 parts |
| Copper phthalocyanine | 5 parts |
| Precipitated barium sulfate | 5 parts |
| MEK | 500 parts |
| Toluene | 500 parts |

### Mixture B:

| | |
|---|---|
| Carbon black B (specific surface area: 8.5 m²/g; average | 100 parts |
| particle size: 270 nm; DBP absorption: 36 ml/100 g: pH: 10) | |
| Nitrocellulose RS1/2 | 40 parts |
| Polyurethane resin | 10 parts |
| MEK | 300 parts |
| Toluene | 300 parts |

Mixture A was preliminarily kneaded in a roll mill. Mixtures A and B were dispersed in a sand grinder. Finally, 5 parts of a polyester resin and 5 parts of polyisocyanate were added thereto to prepare a coating composition for backcoat layer.

### (4) Preparation of Magnetic Recording Web

The nonmagnetic coating composition was applied to one side of a continuous polyethylene naphthalate support having a thickness of 5 μm and a Young's modulus of 6 GPa in MD and 8 GPa in CD to a dry thickness of 1.4 μm and dried. The magnetic coating composition was applied thereto to a dry thickness of 0.1 μm. The magnetic coating layer was magnetically oriented while wet using a cobalt magnet with a magnetic force of 5000 G and a solenoid with a magnetic force of 4000 G and then dried. The backcoating composition was applied to the other side of the support to a dry thickness of 0.5 μm and dried. The coated web was calendered on a 7-roll calender having metal rolls to a thickness of 7 μm. The resulting web was slit under conditions shown in Table 2 below into strips having a width of 12.65±0.01 mm to obtain linear servo system magnetic tapes. The cut surfaces of the tape were observed under a laser microscope to calculate the ratio of the shear region to the thickness of the tape. The results obtained are shown in Table 2.

The resulting magnetic tape was tested on an LTO G4 system to evaluate freedom from servo errors and reduction of dropouts. The number of servo errors per 1000 m on a servo writer and the number of dropouts per meter after 300 hour running on a drive were counted. With respect to freedom from servo errors, a sample with a zero or smaller number of servo errors was rated “good”, a sample with 5 or greater number of servo errors was rated “bad”, and a sample therebetween was rated “medium”. With respect to reduction of dropouts, a sample with 100 or smaller number of dropouts was rated “good”, a sample with 500 or more dropouts was rated “bad”, and a sample therebetween was rated “medium”. The results of evaluation are shown in Table 2.

TABLE 2

| | Ratio of | | | | | |
|---|---|---|---|---|---|---|
| | Shear Region | | | | Engage- | |
| | (%) | | Freedom | | ment | Cutting |
| | Upper | Lower | from | Reduction | Depth | Speed |
| | Blade | Blade | Servo | of | OR | V |
| | Side | Side | Errors | Dropouts | (mm) | (m/min) |
| Example 1 | 52 | 56 | good | good | 0.2 | 400 |
| Example 2 | 63 | 66 | good | good | 0.2 | 200 |
| Example 3 | 75 | 85 | good | good | 0.2 | 100 |
| Comp. | 25 | 35 | medium | bad | 0.8 | 600 |
| Example 1 | | | | | | |
| Comp. | 28 | 52 | medium | bad | 0.5 | 600 |
| Example 2 | | | | | | |
| Comp. | 53 | 31 | medium | medium | 0.8 | 400 |
| Example 3 | | | | | | |

As shown in Table 2, the magnetic recording tapes of Examples 1 to 3 the slit surfaces of which have a shear region in a proportion of 50% or more on both the upper blade side and the lower blade side exhibit satisfactory quality in terms of servo performance and dropout level. In contrast, the magnetic recording tapes of Comparative Examples 1 to 3 the cut surfaces of which have a shear region in a ratio of less than 50% on either one or both of the upper blade side and the lower blade side suffer from frequent occurrences of servo errors and dropouts.

It is understood from the results of the test that the occurrences of servo errors and dropouts are reduced when the ratio of the shear region to the thickness of the magnetic recording tape is 50% or more. The effectiveness of the present invention has thus been proved.

The present invention is not deemed to be limited to the foregoing embodiments and examples, and various changes and modifications can be made therein without departing from the spirit and scope of the invention.

What is claimed is:

1. A magnetic recording medium, which comprises a support and a magnetic layer comprising a ferromagnetic powder and a binder, and has a cut surface along an edge of the magnetic recording medium, wherein the cut surface of the magnetic recording medium has a shear region whose length in a thickness direction of the magnetic recording medium is at least 50% of the thickness of the magnetic recording medium.

2. The magnetic recording medium according to claim 1, which is a magnetic recording tape.

3. The magnetic recording medium according to claim 1, which is a magnetic tape of linear recording system.

4. The magnetic recording medium according to claim 1, wherein the support has a Young's modulus of 8 GPa or more in a width direction.

5. The magnetic recording medium according to claim 1, which is obtained by slitting a magnetic recording web comprising a support having a thickness of 7 μm or less and at least two coating layers on the support and having a total thickness of 9 μm or less into tapes with a width of 12.7 mm or less.

6. The magnetic recording medium according to claim 1, which is obtained by introducing a magnetic recording web between a rotating lower blade and a rotating upper blade mating with the lower blade at a depth of engagement of 0.05 to 0.2 mm to cut the web to size.

7. The magnetic recording medium according to claim 5, which is obtained by introducing the magnetic recording web between a rotating lower blade and a rotating upper blade mating with the lower blade at a depth of engagement of 0.05 to 0.2 mm to cut the web to size.

8. The magnetic recording medium according to claim 1, which is obtained by introducing a magnetic recording web between a rotating lower blade and a rotating upper blade mating with the lower blade at a depth of engagement of 0.2 to 0.5 mm at a speed of 100 to 200 m/min to cut the web to size.

9. The magnetic recording medium according to claim 5, which is obtained by introducing the magnetic recording web between a rotating lower blade and a rotating upper blade mating with the lower blade at a depth of engagement of 0.2 to 0.5 mm at a speed of 100 to 200 m/min to cut the web to size.

10. A process for producing a magnetic recording medium comprising a support and a magnetic layer comprising a ferromagnetic powder and a binder,
the process comprising: introducing a magnetic recording web between a rotating lower blade and a rotating upper blade mating with the lower blade at a depth of engagement of 0.05 to 0.2 mm to cut the web to size.

11. A process for producing a magnetic recording medium comprising a support and a magnetic layer comprising a ferromagnetic powder and a binder,
the process comprising: introducing a magnetic recording web between a rotating lower blade and a rotating upper blade mating with the lower blade at a depth of engagement of 0.2 to mm at a speed of 100 to 200 m/min to cut the web to size.
